(19) United States
(12) Patent Application Publication
(10) Pub. No.: US 2003/0232588 A1
(43) Pub. Date: Dec. 18, 2003

(54) Accessory for a coin handling apparatus

(76) Inventor: Jerry Karlsson, Lund (SE)

Correspondence Address: Steven S. Payne, 8027 ILIFF Drive, Dunn Loring, VA, 22027, US

(21) Appl. No.: 10/170,718

(22) Filed: Jun. 14, 2002

(51) Int. Cl. G07D 3/00

(52) U.S. Cl. 453/15

(57) ABSTRACT

A coin handling apparatus has an accessory for a coin handling apparatus of the type having an essentially horizontal sorting device with at least two external off-sorting stations sequentially arranged along a sorting path, the accessory comprising at least one coin depository and at least one feeding mechanism for recirculating non-sorted coins back into the horizontal sorting device from the coin depository. The coin depository is located adjacent the coin handling apparatus and a deflector is arranged after a last off-sorting station and is adapted to redirect non-sorted coins that have not been sorted out in any of the off-sorting stations into the coin depository.

### TECHNICAL FIELD

The present invention relates to an accessory for a coin handling apparatus of the type having an essentially horisontal sorting device with at least two external off-sorting stations sequentially arranged along a sorting path. The accessory comprises at least one coin depository and at least one feeding mechanism for recirculating non-sorted coins back into the coin sorting device from the coin depository.

### DESCRIPTION OF THE PRIOR ART

Coin deposit machines incorporating such coin handling apparatuses with accessories for recirculation of coins are well-known in the technical field and have been widely used.

One coin deposit machine is disclosed in DE 38 21 947 A1. This machine has a circular and horisontal sorting device and comprises several containers for receiving and depositing coins that have been off-sorted or non-sorted by the coin deposit machine. The machine also wraps sorted coins in tubes for easier distribution. The machine further has two vertical feeders, one of which feeds non-sorted coins from a lower container to a upper container, in which the coins are introduced either by a user or by the feeder itself during an automatic operation. The second feeder moves the tubes of wrapped coins into a container, that can be emptied by an operator.

Another known technology, e g disclosed in WO 97/07485, involves a machine for counting and sorting coins. The machine has a non-horisontal circular sorting device for receiving coins to be sorted, and means for recirculating non-sorted coins, ie coins that have not been sorted out in a first step, back to an initial depository of coins for another sorting attempt.

The main problem with the first-mentioned machine is that it is complicated with multiple containers, for buffering of coins, and two feeders, therefore requiring more careful maintenance. The risk of coin jams is also big due to a lot of connections between all the different containers, which the coins have to pass through. Further, this machine does not handle coins that have not been sorted out in any of the off-sorting stations, and has no function for a continous recirculation of coins. The problem with the second machine is that internal coin jams are difficult to attend to due to a limited accessibility of the internal area for a operator. This machine also has less sorting capacity because of the need of gravity, when the coins are recirculated externally.

### SUMMARY OF THE INVENTION

The main objects of the present invention are to reduce the risk of coin jams, when non-sorted coins are introduced back to a coin handling apparatus for recirculation, and to combine two functions, recirculation and feeding of coins, in one device.

These objects are achieved by an accessory for a coin handling apparatus of the type having an essentially horisontal sorting device with at least two external off-sorting stations sequentially arranged along a sorting path. The accessory comprises at least one coin depository and at least one feeding mechanism for recirculating non-sorted coins back into the horisontal sorting device from the coin depository. The coin depository is located adjacent the coin handling apparatus. Furthermore, a deflector is arranged after a last off-sorting station and is adapted to redirect non-sorted coins, that have not been sorted out in any of the off-sorting stations, into the coin depository.

The deflector is placed between the last off-sorting station and the depository, in such a manner that non-sorted coins will hit the deflector, will be deflected into the depository, and will be recirculated back into the coin handling apparatus by means of the feeding mechanism.

By providing the coin handling apparatus with an accessory with a feeding mechanism and a deflector according to the invention, the following advantages are obtained: coin jams are eliminated due to an external recirculation of non-sorted coins; two functions, recirculation and feeding of coins, are combined in one device giving a more compact design.

### BRIEF DESCRIPTION OF THE DRAWINGS

The present invention will now be described in further detail, reference being made to the accompanying drawings, in which:

FIG. 1 is a perspective view of a preferred embodiment of the accessory together with a coin sorting apparatus;

FIG. 2 is a side view of the accessory together with the coin sorting apparatus;

FIG. 3 is a perspective view from another angle of the accessory together with the coin sorting apparatus;

FIG. 4 is a perspective view from yet another angle of the accessory together with the coin sorting apparatus;

FIG. 5 is a perspective view of the accessory together with the coin sorting apparatus also showing an enlarged part of a deflector comprised in the accessory;

FIG. 6 is a top view of the accessory together with the coin sorting apparatus also showing an enlarged part of the deflector; and

FIG. 7 is a perspective view of the deflector.

### DETAILED DESCRIPTION OF THE INVENTION

In a common coin handling apparatus for sorting and/or counting a plurality of coins, the coins are sorted along either a circular or a linear path with at least two off-sorting stations and a rotatable carrier or sorting device for carrying the coins along the sorting path. The sorting device further comprises a first rotatable means with a first surface and a second rotatable means with a second surface. The first and second surfaces are arranged to rotate at essentially the same speed and are arranged to engage the coins therebetween, thereby transporting the coins essentially frictionless along the sorting path.

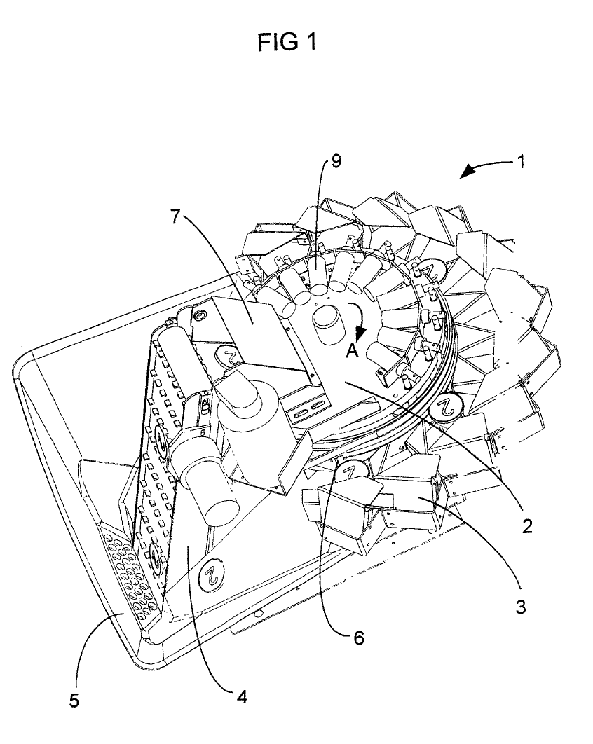

FIG. 1 illustrates a coin handling apparatus 1 with an accessory according to a preferred embodiment of the invention. The accessory comprises a conveyor 4 for moving coins from at least one depository 5, which receives deposited coins, and for introducing coins into the apparatus 1. The coin handling apparatus 1 comprises several off-sorting stations 3 intended to receive off-sorted coins, a horisontal rotatable sorting device 2 for moving coins along a circular sorting path, a coin inlet 7, a detector (not shown) for detecting and recognising respective coin denomination, and several movable members 9 that when actuated deflect a respective coin into a respective off-sorting station 3. The accessory comprises a deflector 6 for redirecting coins, which have not been sorted off for any reason in the coin handling apparatus 1, back into the depository 5 for a off-sort retry. The arrow A shows the direction of rotation for the rotatable sorting device 2.

The coins are introduced by an operator into the depository 5, where a start end of the conveyor 4 is located. The coins come in contact with this end of the conveyor, whereby the coins are picked up and moved into the inlet 7. The conveyor 4 and the depository 5 could be arranged in many ways in relation to each other and the coin handling apparatus. After the conveyor 4 has moved the coins into the inlet 7 and they have been introduced into the rotatable device 2 of the coin handling apparatus 1, the coins are moved around in an internal area of said device 2. The rotation causes the coins to be moved out to the perifery of the internal area, where means (not shown) for moving the coins from this internal area to the outside of the rotatable device 2 are located. This enables each coin to be gripped at a part of its circumference by external grip means of the rotatable device 2, so that a substantial area of each coin is exposed, thereby making this coin area visible for the detector 8. The coin is moved past the detector 8 for detecting and recognising the denomination of each coin. Each coin is then moved in a circular path along the perifery of the rotatable device 2, with its main area visible outside the rotatable device 2. There are several containers, i e the off-sorting stations 3, that are arranged at mutual distances around the perifery of the rotatable device 2 for receiving respective denominations of off-sorted coins. When a respective coin is positioned over a respective coin container, i e the off-sorting station 3, the coin is released from the rotatable device 2 by a respective one of the movable members 9, that pushes out and deflects the coin into its off-sorting station 3. The movable members 9 are placed round the rotatable device 2 in a way that corresponds to the off-sorting stations 3.

Coins that have not been recognised for whatever reason are recirculated back into the coin handling apparatus 1, thereby enabling at least one more retry for detection, recognition and off-sorting. This recirculation is achieved in the following way. A non-sorted coin, i e a coin that is not recognised, will move past every off-sorting station 3, including the last one, and will hit the deflector 6, which is placed after the last off-sorting station 3. The coin is deflected by the deflector 6 and falls into the coin depository 5, which is used for receiving coins, that are introduced into the apparatus 1. This enables the coins to be conveyed by the conveyor 4 from the depository 5 and back into the coin handling apparatus 1.

This recirculation of a certain coin denomination can be desirable for several reasons: An off-sorting station 3 can be full, out of order or have jammed coins, so that off-sorting can not be commenced, until the station is replaced by an empty container or is repaired. The recirculation also enables an automatic switch between a full broken or jammed station 3 for a certain coin denomination and another functioning station, so that a continuous operation of the apparatus is possible until, appropriate measures are taken, and the off-sorting in the initial station can be resumed again.

Recirculation as described above has an additional advantage in that coins that are too close to each other, or on top of each other, will be given a new opportunity to be duly sorted.

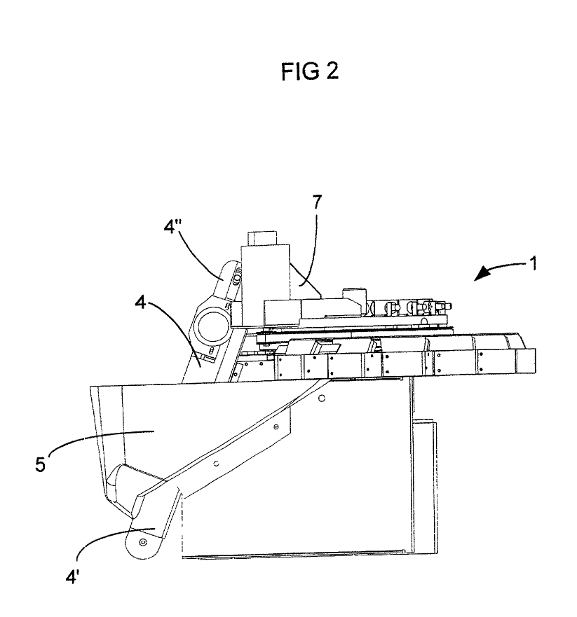

FIG. 2 discloses a side view of the coin handling apparatus 1. The depository 5 for receiving coins is placed below the apparatus 1 and has one end 4′ of the conveyor 4 protruding through it. The upper end 4″ of the conveyor 4 ends in the inlet 7 for introducing coins into the coin sorting device 2.

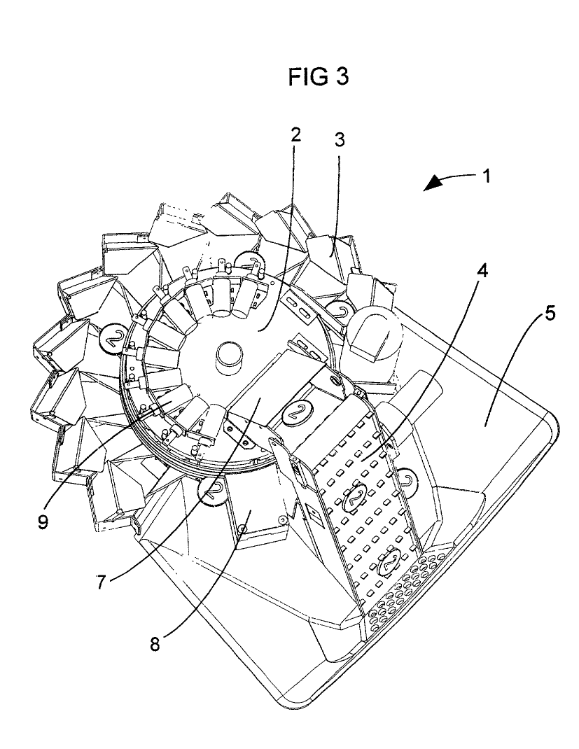

FIG. 3 shows the coin handling apparatus 1 of FIG. 1 from another angle. The detector 8 for detecting, recognising, and verifying denominations of coins to be off-sorted is arranged adjacent the inlet 7.

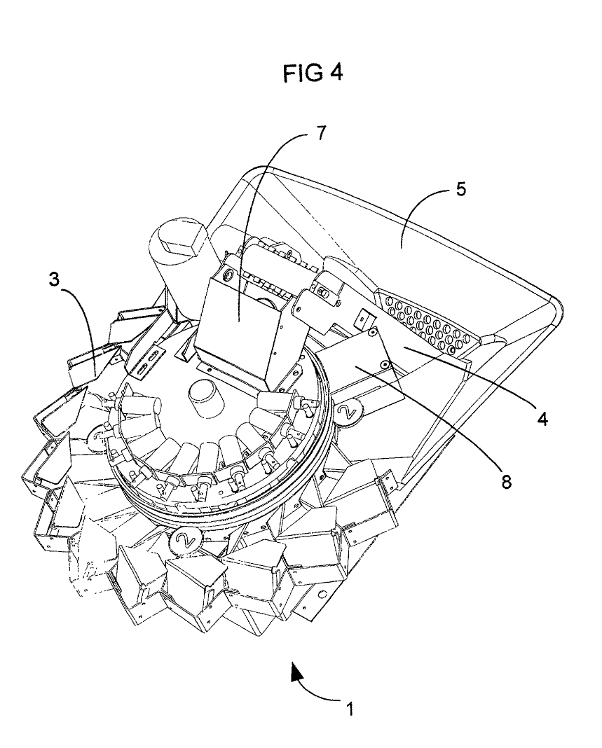

FIG. 4 shows the coin handling apparatus 1 according to FIGS. 1 and 3 from yet another angle.

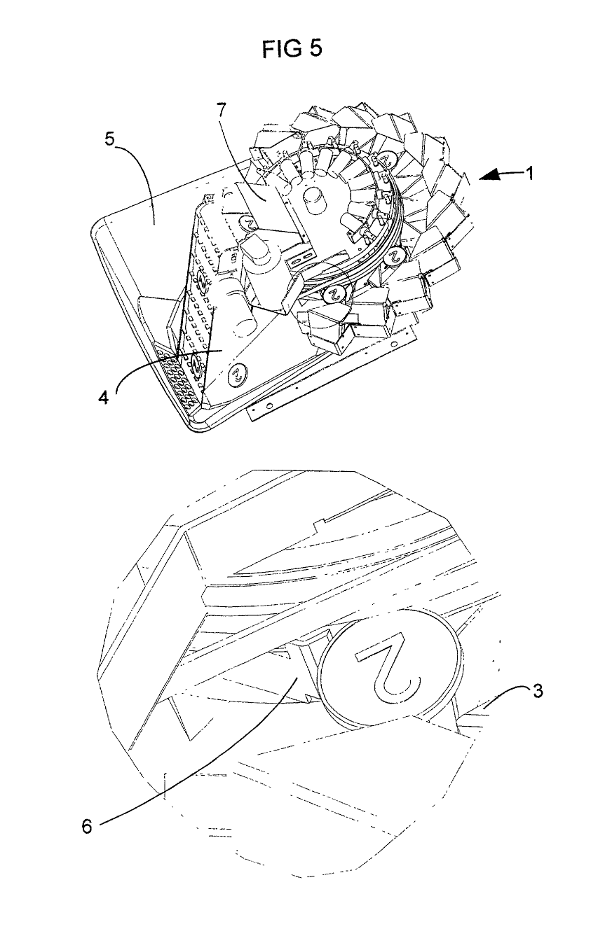

FIG. 5 shows the coin handling apparatus 1 of FIG. 1 in a reduced scale with the deflector 6 shown in an enlarged scale. FIG. 5 shows the deflector 6 and a non-sorted coin, which is going to be recirculated for another attempt to recognise it and sort it out. The coin is shown just before it hits the deflector 6 and is, after the hit, redirected into the depository 5, where the conveyor 4 picks up said coin and moves it through the inlet 7 back into the coin sorting device 2.

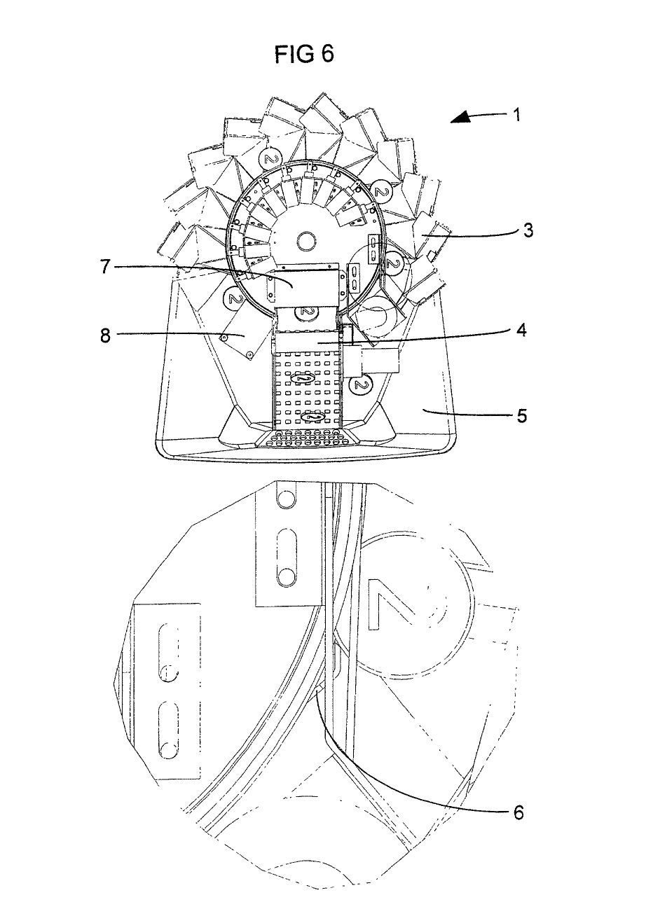

A top view of the coin handling apparatus of FIGS. 1-5 is shown in FIG. 6. The deflector 6 is shown in enlarged scale for clarity reasons.

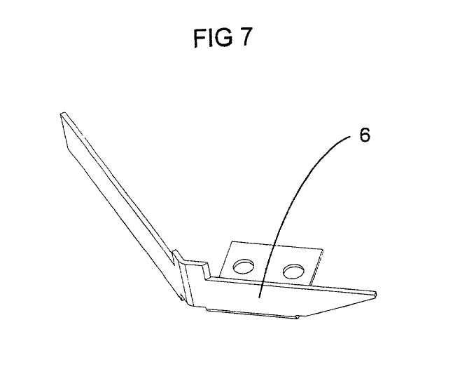

FIG. 7 shows the deflector 6 in detail. The deflector 6 has a substantially flat knife-shaped design, such as a plate bar, and is bent to correspond to the circular perifery of the sorting device 2, when it is attached thereto. The deflector 6 is also arranged so that one of its edges faces an incoming non-sorted coin and deflects the coin when it hits the plate bar 6.

1. An accessory for a coin handling apparatus (1) of the type having an essentially horisontal sorting device (2) with at least two external off-sorting stations (3) sequentially arranged along a sorting path, the accessory comprising at least one coin depository (5) and at least one feeding mechanism (4) for recirculating non-sorted coins back into the horisontal sorting device (2) from the coin depository,
characterized
in that the coin depository (5) is located adjacent the coin handling apparatus (1),
and in that a deflector (6) is arranged after a last off-sorting station (3) and is adapted to redirect non-sorted coins, that have not been sorted out in any of the off-sorting stations, into the coin depository (5).

2. An accessory according to claim 1, wherein the deflector (6) is placed between the last off-sorting station (3) and the depository (5), in such a manner that non-sorted coins hit the deflector (6), are deflected into the depository (5) and are recirculated back into the coin handling apparatus (1) by means of the feeding mechanism (4).

3. An accessory according to claim 2, wherein the deflector (6) is attached to the coin handling apparatus (1).

4. An accessory according to claim 3, wherein the deflector (6) is placed at the perifery of the coin handling apparatus (1) for deflecting the coins down into the depository (5), so that they can be recirculated back into the coin handling apparatus (1) by means of the feeding mechanism (4), in the form of a conveyor belt.

5. An accessory according to claim 4, wherein the deflector (6) has a substantially flat design, such as a plate bar, and is arranged so that one of its edges faces an incoming non-sorted coin and deflects said coin when it hits the plate bar (6).

6. An accessory according to claim 5, wherein the feeding mechanism (4), in the form of a conveyor belt, ends above the coin handling apparatus (1) for feeding the coins into said coin handling apparatus (1), and starts in the depository (5) below the coin handling apparatus (1), so that coins may be easily brought up from said depository (5).
